(19) United States
(12) Patent Application Publication
(10) Pub. No.: US 2013/0115492 A1
(43) Pub. Date: May 9, 2013

(54) SEALED TYPE BATTERY

(71) Applicant: Kinya Aota, Hitachi (JP)

(72) Inventor: Kinya Aota, Hitachi (JP)

(73) Assignee: HITACHI VEHICLE ENERGY, LTD., Ibaraki (JP)

(21) Appl. No.: 13/809,281

(22) PCT Filed: Feb. 23, 2011
(86) PCT No.: PCT/JP2011/053970

§ 371 Date: Jan. 9, 2013

(30) Foreign Application Priority Data
Jul. 9, 2010 (JP) 2010-156496

(51) Int. Cl. H01M 2/36

(52) U.S. Cl. CPC H01M 2/362
USPC 429/82

(57) ABSTRACT

A sealed type battery includes: a can where an electrode winding group; a lid which has a liquid filling hole for injecting a liquid electrolyte and seals an opening of the can; and a liquid filling tap which is fitted to the liquid filling hole and seals the liquid filling hole by welding. A projection molten in welding is provided on one of the outer surface of the liquid filling tap and the outer surface of the lid connected to the liquid filling hole. The liquid filling tap is welded to the liquid filling hole using molten metal of the projection in welding as well.

### TECHNICAL FIELD

This invention relates to a sealed type battery such as a lithium secondary battery.

### BACKGROUND ART

Recently a large-sized prismatic lithium secondary battery has been the object of our attention, which can be charged and discharged with a large capacity as a power source such as a hybrid vehicle and an electric vehicle, and has a high volume energy density (Wh/L).

In the prismatic lithium secondary battery, a positive electrode foil to which positive active material is applied, a negative electrode foil to which negative active material is applied and a separator for insulating them from each other are wound to form a flat-shaped electrode winding group, the group is stored in a can, and a positive electrode terminal, a negative electrode terminal and the electrode winding group provided on a lid and exposed to the outside are electrically connected. A liquid electrolyte is injected into the can, and the electrode winding group is soaked in the liquid electrolyte. The liquid electrolyte is injected from a liquid filling hole provided in the can. Since leakage of the liquid electrolyte causes a problem such as corrosion of the can, after the liquid electrolyte is injected, the liquid filling hole is sealed and welded by laser welding and the can is sealed.

In this type of sealed type battery, the welding quality of the liquid filling hole is important. Therefore, for example, a clearance gap is partially provided between an aluminum-made liquid filling hole and an aluminum-made tap, whereby the liquid electrolyte volatilized by heat input in laser welding is released to prevent welding failure (Patent literature 1).

### CITATION LIST

### Patent Literature

Patent Literature 1: Japanese Unexamined Patent Application Publication No. 2009-199819

### SUMMARY OF INVENTION

### Technical Problem

Although the construction of the latent literature 1 is effective for a small-sized battery, the large-sized battery is increased in size of the lid and liquid filling tap and dimensional tolerance is large, so that an excessive clearance gap is sometimes caused. Then, weld metal for sealing the clearance gap is short, resulting in the possibility of causing welding defect such as a crack.

### Solution to Problem

(1) A sealed type battery of the invention includes: a can where an electrode winding group is stored; a lid having a liquid filling hole for injecting a liquid electrolyte and sealing an opening of the can; and a liquid filling tap fitted to the liquid filling hole to thereby seal the liquid filling hole by weld. Either the outer surface of the liquid filling tap or the outer surface of the lid connected to the liquid filling hole is provided with a projection molten in welding, and the liquid filling tap is welded to the liquid filling hole also using the molten metal of the projection in welding.

The projection is preferably formed annularly to project from the outer surface of the outer peripheral edge of the liquid filling tap.

In this example, when an annular groove recessed from the outer surface of the liquid filling tap is formed on the inside of the projection protruded from the outer surface of the liquid filling tap, some of the molten metal in welding is exposed to the groove and solidified. This is further preferable.

Instead of forming the groove in the liquid filling tap, an annular groove recessed from the outer surface of the lid may be formed along the outside of the inner peripheral surface of the liquid filling hole. Also in this example, some of the molten metal is exposed to the groove and solidified, so that favorable weld quality can be obtained.

When an annular groove recessed from the outer surface of the lid is formed along the outside of the inner peripheral surface of the liquid filling hole in addition to the groove of the liquid filling tap, some of the molten metal in welding is exposed to the grooves of the liquid filling tap and the lid and solidified, so that further favorable weld quality can be obtained.

(2) The projection may be formed annularly to project from the outer surface of the lid connected to the inner peripheral surface of the liquid filling hole.

Also in this example, when an annular groove recessed from the outer surface of the lid is formed on the outside of the projection protruded from the outer surface of the like, some of the molten metal in welding is exposed to the groove and solidified, so that favorable weld quality can be obtained.

Instead of the groove of the lid, an annular groove recessed from the outer surface of the liquid filling tap maybe formed. Also in this example, some of the molten metal in welding is exposed to the groove and solidified, so that favorable weld quality can be obtained.

(3) A first annular projection formed annularly to project the outer surface of the outer peripheral edge of a liquid filling tap and a second annular projection formed annularly to project from the outer surface of the lid adjacent to the inner peripheral surface of the liquid filling hole may be both provided.

In this example, the first annular groove recessed from the outer surface of the liquid filling tap maybe formed inside the first annular projection protruded from the outer surface of the liquid filling tap. In this case, some of the molten metal in welding is exposed to the first groove and solidified, so that favorable weld quality can be obtained.

Alternatively, the second annular groove recessed from the outer surface of the lid may be formed on the outside of the second projection protruded from the outer surface of the lid. In this case, some of the molten metal in welding is exposed to the second groove and solidified, so that favorable weld quality can be obtained.

An annular groove recessed from the outer surface of the liquid filling tap may be further formed on the peripheral edge part of the liquid filling tap. In this example, some of the molten metal in welding is exposed to the grooves of the liquid filling tap and the lid and solidified, so that favorable weld quality can be obtained.

(4) The first and second annular projections and the first and second annular grooves may be respectively provided. In this case, some of the molten metal in welding is exposed to the first and second grooves and solidified, so that further favorable weld quality can be obtained.

(5) The liquid filling hole may be constructed to include a large diameter part and a small diameter part which form a step part.

In this example, a liquid filling tap includes: a head part placed on the step part and fitted to the large diameter part; and a shaft part fitted to the small diameter part, the shaft center of which is aligned therewith, and the outer peripheral edge of the head part is welded to the inner peripheral edge of the large diameter part of the liquid filling hole. In this case, preferably the lid is increased in wall thickness at a portion corresponding to the small diameter part of the liquid filling hole, and the shaft part of the liquid filling tap is formed to have the same length equal to the wall thickness.

It is preferable that the liquid filling tap is circular and the projection is annular.

The projection is preferably protruded to project from the outer surface of the liquid filling tap or the outer surface of the lid so that the top face thereof is located at a position from which the projection is projected from the outer surface of the lid.

### Advantageous Effects of the Invention

According to the invention, in welding a liquid filling hole and a liquid filling tap, the weld quality can be stably improved.

### BRIEF DESCRIPTION OF THE DRAWINGS

FIG. 1 is a perspective view showing a sealed type battery in a first embodiment of a sealed type battery according to the invention.

FIG. 2 is a perspective view showing a lid assembly including an electrode winding group of FIG. 1.

FIG. 3 is an exploded view showing the electrode winding group of FIG. 2.

FIG. 4 is a longitudinal section taken in the directions of arrows A-B in FIG. 1, showing the condition before a liquid filing tap of the sealed type battery is welded.

FIG. 5 is a longitudinal section showing the condition after the weld part of FIG. 4 is welded.

FIG. 6 is a longitudinal section showing a weld part in a second embodiment of a sealed type battery according to the invention.

FIG. 7 is a longitudinal section showing a weld part in a third embodiment of a sealed type battery according to the invention.

FIG. 8 is a longitudinal section showing a weld part in a fourth embodiment of a sealed type battery according to the invention.

FIG. 9 is a longitudinal section showing a weld part in a fifth embodiment of a sealed type battery according to the invention.

FIG. 10 is a longitudinal section showing a weld part in a sixth embodiment of a sealed type battery according to the invention.

FIG. 11 is a longitudinal section showing a weld part in a seventh embodiment of a sealed type battery according to the invention.

FIG. 12 is a longitudinal section showing a weld part in an eighth embodiment of a sealed type battery according to the invention.

FIG. 13 is a longitudinal section showing a weld part in a ninth embodiment of a sealed type battery according to the invention.

FIG. 14 is a longitudinal section showing the condition after the weld part of FIG. 13 is welded.

FIG. 15 is a longitudinal section showing a weld part in a tenth embodiment of a sealed type battery according to the invention.

FIG. 16 is a longitudinal section showing a weld part in an eleventh embodiment of a sealed type battery according to the invention.

FIG. 17 is a longitudinal section showing a weld part in a twelfth embodiment of a sealed type battery according to the invention.

FIG. 18 is a longitudinal section showing a weld part in a thirteenth embodiment of a sealed type battery according to the invention.

FIG. 19 is a longitudinal section showing a weld part in a fourteenth embodiment of a sealed type battery according to the invention.

### DESCRIPTION OF EMBODIMENTS

Embodiments where the sealed type battery of the invention is applied to a lithium secondary battery will be described with reference to the drawings.

### First Embodiment

### [Construction of Secondary Battery]

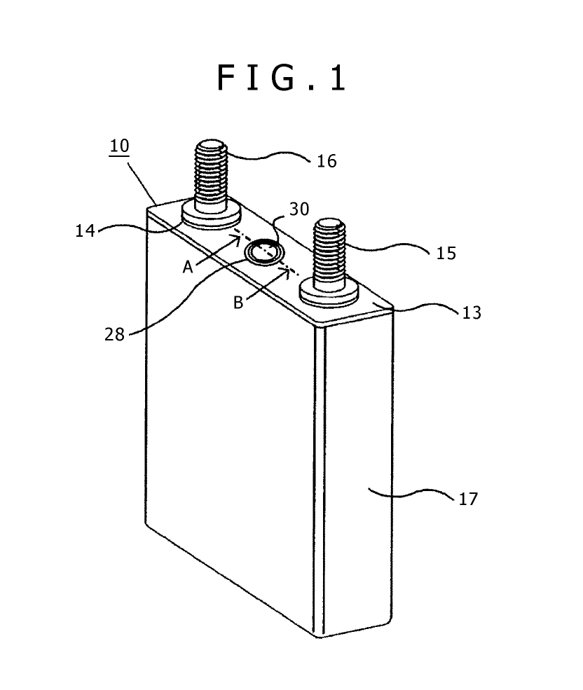

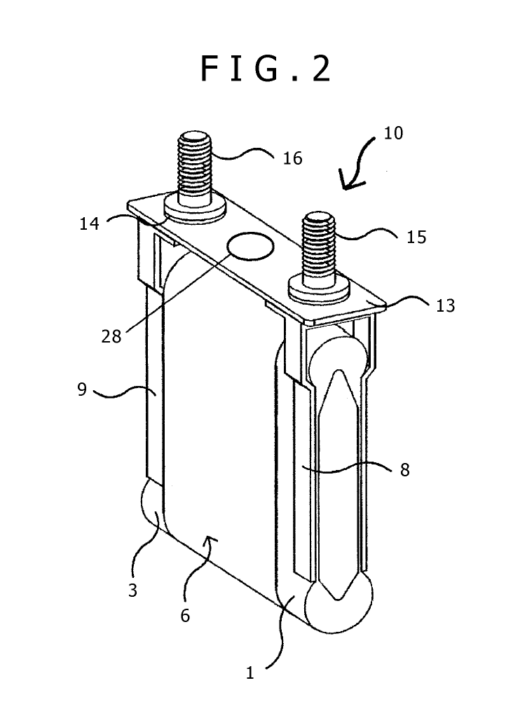

As shown in FIG. 1 and FIG. 2, a sealed type battery includes a can 17 having an opening at one end and a lid assembly 10 assembled in the can 17. The lid assembly 10 includes a lid 13 and an electrode winding group 6 fitted to the lid 13, and the lid 13 is provided with positive and negative electrode terminals 15, 16 and a circular liquid filling hole 28. The liquid filling hole 28 is sealed with a circular liquid filling tap 30. The material quality of the can 17 and the lid 13 is aluminum. The lid 13 is welded to the can 17 to thereby secure the lid assembly 10 to the can 17, and the opening of the can 17 is closed by the lid 13.

After the lid assembly 10 is welded to the can 17, a liquid electrolyte (not shown) is injected into the can 17 from the liquid filling hole 28. After that, the liquid filling hole 28 is sealed with the liquid filling tap 30. The liquid filling tap 30 is secured to the liquid filling hole 28 by laser welding.

### [Lid Assembly]

As shown in FIG. 1 and FIG. 2, the lid assembly 10 further includes current collectors 8, 9 of positive and negative electrodes, and the current collectors 8, 9 of positive and negative electrodes are respectively connected to metal foil exposed parts of positive and negative electrode sheets 1, 3 in the electrode winding group 6. The current collectors 8, 9 of positive and negative electrodes are respectively electrically connected to the positive and negative electrode terminals 15, 16, and also electrically insulated from the lid 13. The positive and negative terminals 15, 16 are fitted to the lid 13 through an insulating seal member 14 to be electrically insulated from the lid 13. Thus, the positive and negative electrode terminals 15, 16 are respectively connected to the positive and negative electrode foils 1, 3 of the electrode winding group 6 while being electrically insulated from the lid 13.

### [Electrode Winding Group]

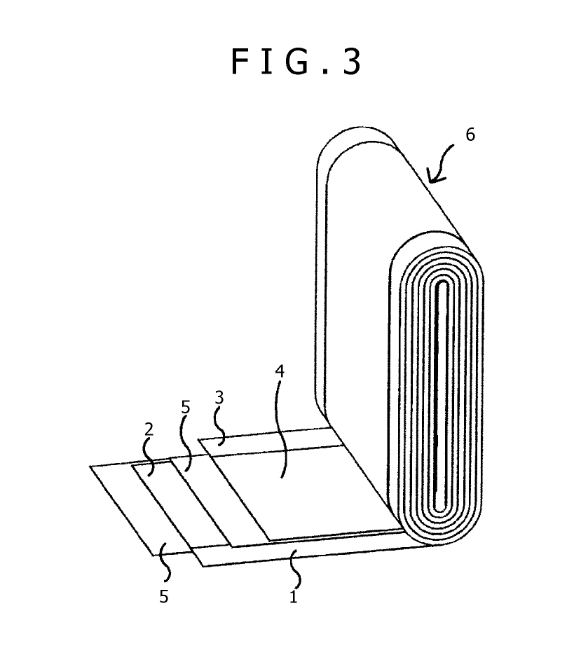

As shown in FIG. 3, the electrode winding group 6 is constructed by winding a positive electrode 1 where positive active material 2 is applied to both surfaces of a positive electrode foil and a negative electrode 3 where negative active material 4 is applied to both surfaces of a negative electrode foil with a separator 5 interposed between them in a flat shape. The positive electrode foil 1 is made of aluminum and 30 μm thick, and the negative electrode foil 3 is made of copper and 15 μm. The separator 5 is made of porous polyethylene resin. Electric charge and discharge are performed between the positive active material 2 on both surfaces of the positive electrode 1 and the negative active material 4 on both surfaces of the negative electrode 3.

### [Sealing of Liquid Filling Hole]

In order to prevent leakage of the liquid electrolyte, it is necessary to secure the liquid filling tap 30 to the liquid filling hole 28 by high quality weld using enough weld metal. For the shortage of weld metal, it is considered to add a member such as a filler wire, but the machining cost is increased. In the present embodiment, a desired weld quality can be obtained only by improvement in shape of a welded joint.

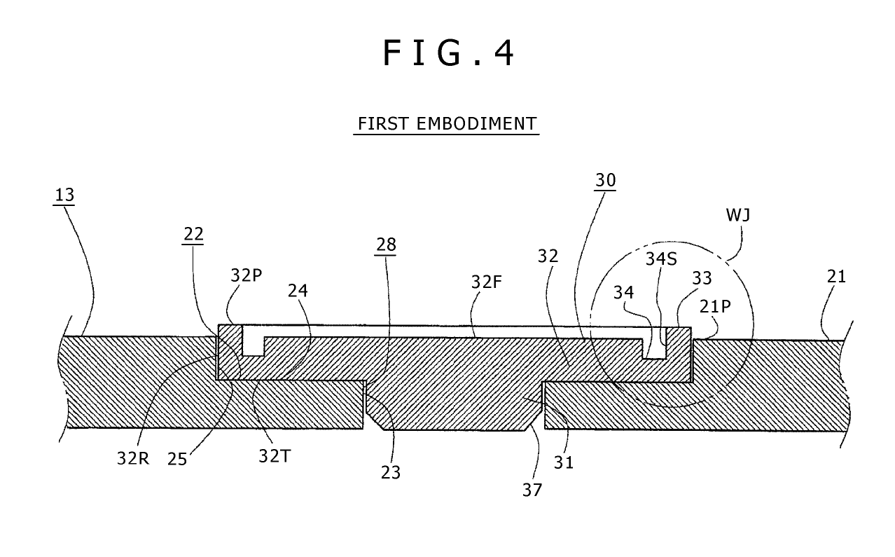

As shown in FIG. 4, the liquid filling hole 28 includes a circular through hole 23 and a step part 22 connected to the outer periphery of the through hole 23 and opened to the outside. The step part 22 includes a bearing surface 24 having a circular plane surface and a fitting part 25 having a cylindrical surface. The bearing surface 24 is parallel to the outer surface 21 of the lid 13 and faces the outside. The fitting part 25 is raised from the periphery of the bearing surface 24 at right angles to the outer surface 21 up to the outer surface 21. In other words, the liquid filling hole 28 includes a large diameter step part 22 and a small diameter through hole 23.

The liquid filling tap 30 includes a shaft part 31 fitted in the through hole 23 and a head part 32 stored in the step part 22, and the head part 32 is positioned and supported by the step part 22. The tip part of the shaft part 31 is subjected to chamfering 37, so that in inserting the liquid filling tap 30 in the liquid filling hole 28, the shaft part 31 is smoothly introduced into the through hole 23.

An annular abut surface 32T abutted on the bearing surface 23 is formed on the head part 32, so that with the liquid filling tap 30 inserted in the liquid filling hole 28, the abut surface 32T comes into contact with the bearing surface 24, whereby the head part is positioned and supported by the bearing surface 24 with respect to the direction of entering and leaving the liquid filling hole 28. Further, the outer peripheral surface 32R of the head part 32 confronts the inner peripheral surface of the fitting part 25 with a predetermined clearance gap. The size of the clearance gap will be mentioned later.

An annular projection 33 raised outside higher than the outer surface 31 of the lid 13 is formed on the peripheral edge part 32 of the outer surface 32F in the head part 32, and an annular groove 34 recessed from the outer surface 32F along the projection 33 is formed on the inside of the projection 33. In welding the liquid filling tap 30 to the liquid filling hole 28, a peripheral edge part 21P, the projection 33 and the groove 34 in the outer surface 21 constitute a welded joint WJ.

The dimensions of the respective parts are set so that when the liquid filling tap 30 is fitted to the fitting part 25, the outer surface 32F in the head part 32 and the outer surface 21 of the lid 13 are equal to each other in height position.

In welding, YAG pulse laser welding machine is, for example, used, and a laser beam is applied to the weld joint WJ with 6J of energy/one pulse, with a pulse frequency of 60 pulses/sec., an average output of 360 W, and at a weld speed of 10 mm/sec. At this time, the laser beam melts the weld joint WJ, and the melt range extends to a side surface 34S of the groove 34.

At this time, the projection 33 is molten together with the peripheral edge part 21P, so that enough capacity of molten metal, that is, molten aluminum is generated extending over the whole peripheries of the peripheral edge parts 21P, 32P. The molten aluminum stays on the peripheral edge parts 21P, 32P due to its surface tension, and closes clearance gaps on the whole peripheries of the peripheral edge parts 21P, 32P while being raised outside. Thus, the clearance gaps in the peripheral edge parts 21P, 32P are surely sealed.

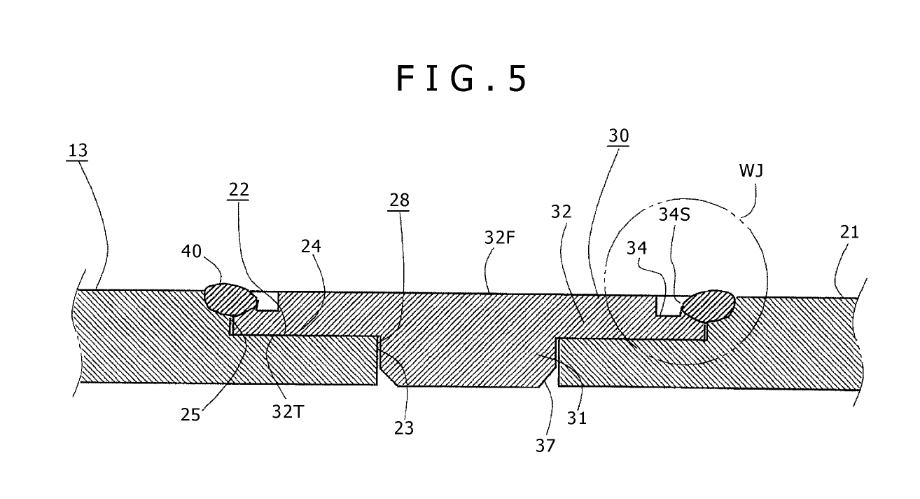

As shown in FIG. 5, the inner periphery of a weld metal 40 raised by coagulation of molten metal faces the groove 34, so that the inner peripheral side of the weld metal 40 is opened. In pulse laser welding, especially, in welding aluminum, the coagulation speed is high, and crack sensitivity is high. However, the weld metal 40 is opened to the side by the groove 34, so that the weld metal 40 as the final coagulation part does not cause tensile stress in the radial direction. Thus, the crack of the weld metal can be prevented, and the liquid filling hole 28 can be sealed with favorable weld quality.

The width and height of the projection 33 are set so that when the clearance gaps of the peripheral edge parts 21P, 32P are upper limits of tolerance, enough molten metal can be supplied to cover in the clearance gaps while the weld metal is raised.

For example, the inside diameter of the fitting part 25 is set to 12.1±0.05 mm, and the head part 32 of the liquid filling tap 30 has an outside diameter of 12.0±0.05 mm. At this time, the clearance gaps of the peripheral edge parts 21P, 32P are 0 mm at minimum and 0.2 mm at maximum according to the dimensional tolerance. When the head part 32 is thus set to a smaller diameter than the fitting part 25, insertion to the liquid filling hole 28 is facilitated. In this case, when the projection 33 is 0.4 mm wide and 0.2 mm high from the outer surface 21, and the groove 34 is 0.4 mm wide and 0.4 mm deep from the outer surface 21, favorable weld quality can be obtained.

The groove 34 is thus provided, whereby a heat transfer passage for transferring heat of the molten metal to the liquid filling tap 30 is narrowed to restrain heat radiation. Therefore, in welding, enough depth of fusion can be obtained with a small heating value, and it is effective for preventing a temperature rise of the liquid electrolyte.

In the welded joint WJ of the present embodiment, when a clearance gap of 0.2 mm at maximum occurs, favorable weld can be achieved without defect such as a defect.

As described above, it is necessary to select the width and height of the projection 33 according to the dimensions of a supposed clearance gap, and form the projection 33 of such a capacity that the weld metal 40 to cover in the clearance gap is not short. In the large-sized battery, the projection 33 with a capacity corresponding to a large clearance gap is required.

However, when the projection 33 is large to excess, large laser output is needed for melting the projection 33, and the liquid electrolyte in the can 17 is heated, resulting in the possibility of deteriorating the battery characteristic. Therefore, the capacity of the projection 33 should be set to the minimum as long as the weld metal 40 is not short.

### Second Embodiment

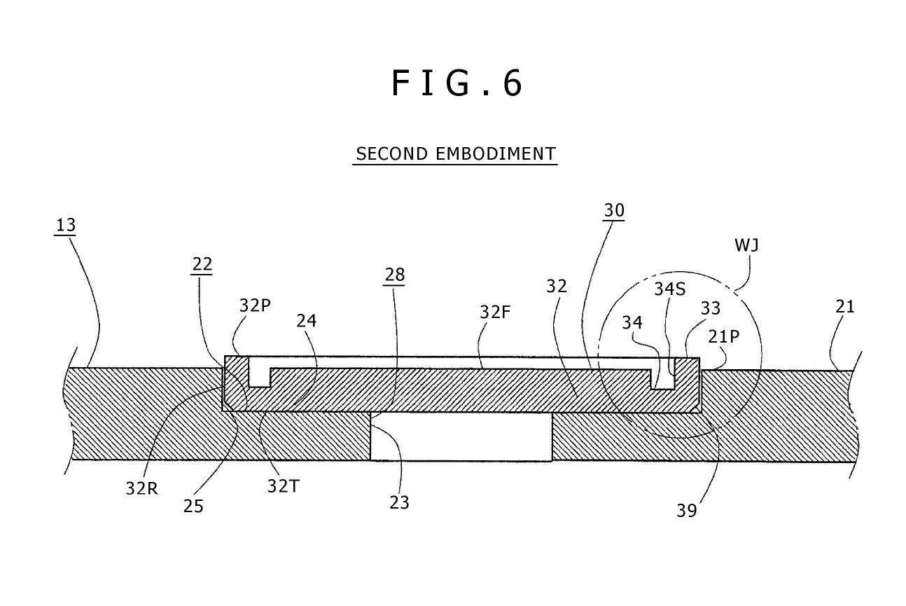

A second embodiment of a sealed type battery according to the invention will be described with reference to FIG. 6. In the drawing, the same or corresponding parts as those of the first embodiment are designated by the same reference numerals and the description will be eliminated.

In the second embodiment, the shaft part 31 of the liquid filling tap 30 in the first embodiment is eliminated.

As shown in FIG. 6, a liquid filling hole 28 in a sealed type battery is provided with a through hole 23 and a fitting part 25 similar to those of the first embodiment. On the other hand, a liquid filling tap 30 is formed disk-like to have the same thickness and outside diameter as those of the head part 32 of the first embodiment, and the inner surface thereof is an annular abut surface 32T abutting on a bearing surface 24. In the liquid filling tap 30, the periphery of the abut surface 32T is subjected to chamfering 39, whereby in inserting the liquid filling tap 30 into the liquid filling hole 28, the liquid filling tap 30 can be smoothly introduced into the fitting part 25. With the liquid filling tap 30 inserted into the liquid filling hole 28, the abut surface 32T comes into contact with the bearing surface 24, whereby the tap is positioned and supported with respect to the direction of entering and leaving the liquid filling hole 28. Further, the outer peripheral surface 32R of the head part 32 confronts the inner peripheral surface of the fitting part 25 with a predetermined clearance gap. The dimensions of the clearance gap are similar to those of the above description.

An annular projection 33 raised outside higher than an outer surface 21 similarly to the first embodiment is formed on a peripheral edge part 32P of an outer surface 32F of the liquid filling tap 30, and an annular groove 34 is formed along a projection 33 on the inside of the projection 33. In the present embodiment, a welded joint WJ is similar to that of the first embodiment.

According to the second embodiment, the construction of the liquid filling tap 30 can be simplified, and in addition to the effect of the first embodiment, the effect of reducing the manufacturing cost can be obtained.

### Third Embodiment

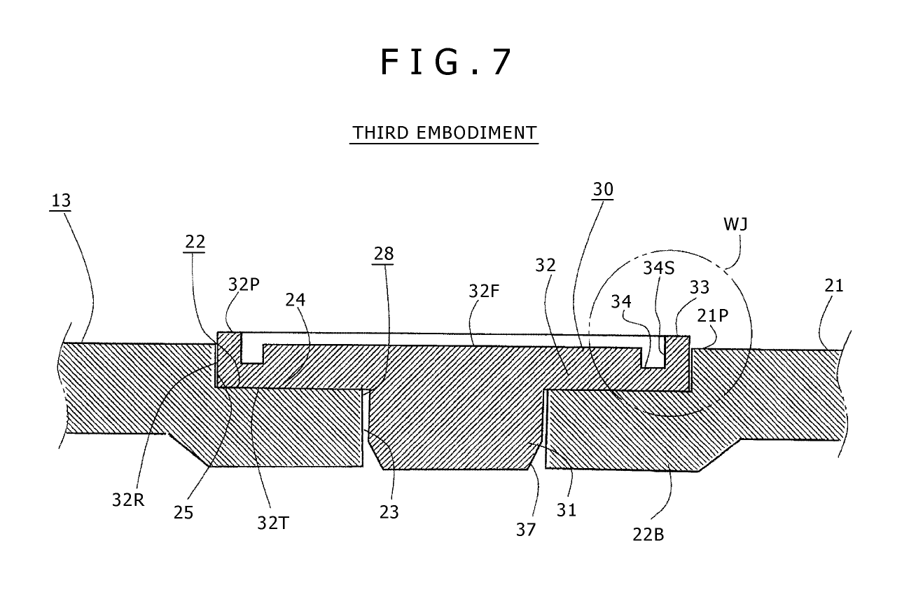

A third embodiment of a sealed type battery according to the invention will be described with reference to FIG. 7. In the drawing, the same or corresponding parts as those of the first embodiment are designated by the same reference numerals and the description is eliminated.

In the third embodiment, the lid 13 of the first embodiment is increased in wall thickness at a portion in the periphery of a liquid filling hole 28, and also a shaft part 31 of a liquid filling tap 30 is set longer.

As shown in FIG. 7, a lid 13 is provided with the liquid filling hole 28, and the liquid filling hole 28 includes a circular through hole 23 and a step part 22 connected to the outer periphery of the through hole 23 and opened to the outside. The step part 22 includes a bearing surface 24 having a circular plane surface and a fitting part 25 having a cylindrical surface. The bearing surface 24 is parallel to an outer surface 21 of the lid 13 and faces the outside. The fitting part 25 is raised from the periphery of the bearing surface 24 at right angles to the bearing surface 24 up to the outer surface 21.

The liquid filling tap 30 includes the shaft part 31 corresponding to the through hole 23 and a head part 32 corresponding to the step part 22, and the head part 32 is positioned and supported by the step part 22. A tip part of the shaft part 31 is subjected to chamfering 37, whereby in inserting the liquid filling tap 30 into the liquid filling hole 28, the shaft part 31 can be smoothly introduced into the through hole 23.

An annular abut part 32T abutting on the bearing surface 24 is formed on the head part 32, and with the liquid filling part 30 inserted into liquid filling hole 28, the abut surface 32T comes into contact with the bearing surface 24, whereby the head part is positioned and supported by the bearing surface 24 with respect to the direction of entering and leaving the liquid filling hole 28. Further, an outer peripheral surface 32R of the head part 32 confronts the inner peripheral surface of the fitting part 25 with a predetermined clearance gap. The dimensions of the clearance gap are similar to those of the above description.

An annular projection 33 raised to the outside higher than the outer surface 21 is formed on a peripheral edge part 32P of an outer surface 32F of the head part 32, and an annular groove 34 is formed along the projection 33 on the inside of the projection 33. In the present embodiment, a welded joint WJ is similar to that of the first embodiment.

A boss 22B is projected on the inner surface of the lid 13 in the periphery of the through hole 23, and a lid member where the bearing surface 24 of the step part 22 is formed has a larger wall thickness as compared with the first embodiment. Thus, the through hole 23 is set longer than that of the first embodiment, and the shaft part 31 is set longer corresponding to the through hole 23. The lid member where the bearing surface 24 of the step part 22 is formed to have a larger wall thickness, and the shaft part 31 is set longer, whereby the weld part and the interior of the battery can be separated from each other, so that it is effective for restraining a temperature rise of the liquid electrolyte and preventing deterioration of battery characteristic. That is, according to the present embodiment, the effect of restraining a temperature rise of the liquid electrolyte can be produced in addition to the effect of the first embodiment.

### Fourth Embodiment

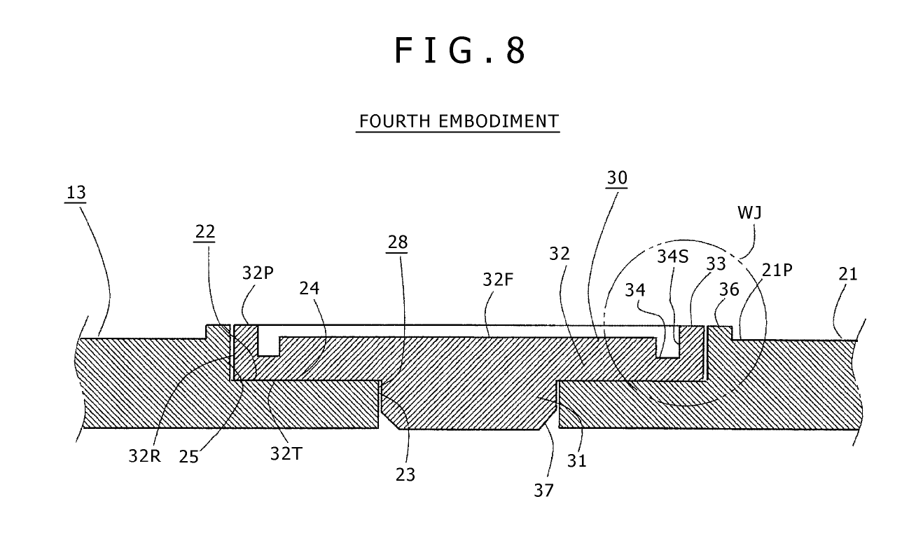

A fourth embodiment of a sealed type battery according to the invention will be described with reference to FIG. 8. In the drawing, the same or corresponding parts as those of the first embodiment are designated by the same reference numerals and the description is eliminated.

According to the fourth embodiment, in a welded joint WJ, a peripheral edge part 21P is provided with a projection 36 in addition to a projection 33 and a groove 34 similar to those of the first embodiment.

As shown in FIG. 8, an annular projection 36 is formed along the projection 33 on the peripheral edge part 21P. The projection 36 is laid along the inner peripheral surface of a fitting part 25 and also along the outer peripheral surface of the projection 33. That is, the projections 33 and 36 are disposed enough adjacent to each other, and the clearance gap between the projections 33 and 36 are held down to the minimum. The top faces of the projections 33, 36 are set substantially equal to each other.

In the present embodiment, the welded joint WJ are constituted by the projections 33, 36 and the groove 34, and in welding, molten metal for weld metal (not shown) is supplied from the projections 33, 36. According to the present embodiment, the effect of increasing the capacity of molten metal can be obtained in addition to the effect of the first embodiment.

### Fifth Embodiment

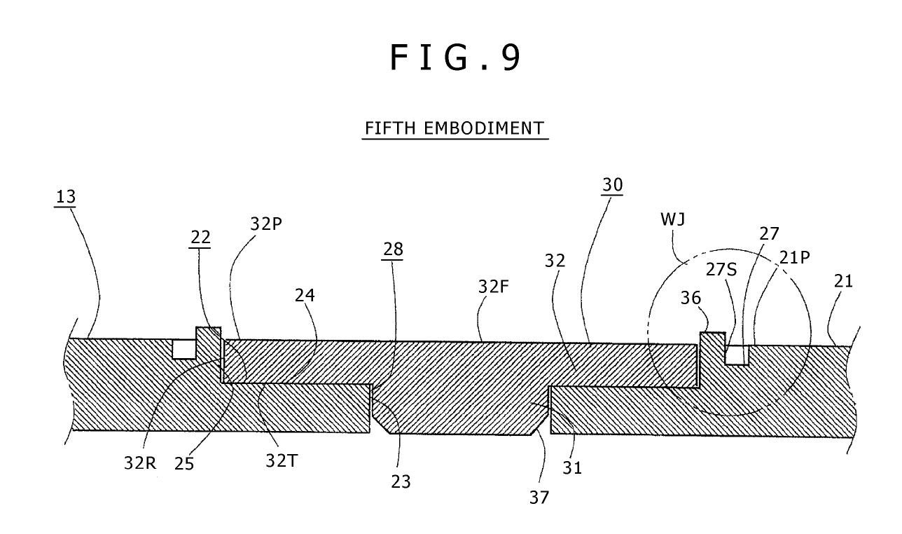

A fifth embodiment of a sealed type battery according to the invention will be described with reference to FIG. 9. In the drawing, the same or corresponding parts as those of the first embodiment are designated by the same reference numerals and the description is eliminated.

According to the fifth embodiment, in a welded joint WJ, a projection 36 and a groove 27 are provided on a peripheral edge part 21p instead of the projection 33 and the groove 34 in the first embodiment.

As shown in FIG. 9, an outer surface 32F in a head part 32 of a liquid filling tap 30 is a plane surface, and is not provided with the projection 33 and the groove 34. On the other hand, the annular projection 36 is formed along a peripheral edge part 32P of the head part 32 on the peripheral edge part 21P in a lid 13, and an annular groove 27 is formed along the projection 36 on the outside of the projection 36. The projection 36 is laid along the inner peripheral surface of a fitting part 25. The groove 27 is recessed from an outer surface 21 of the lid 13.

In the present embodiment, a welded joint WJ is constituted by the projection 36 and the groove 27. In welding, the projection 36 supplies enough molten metal for weld metal (not shown), which stays in the peripheral edge parts 21P, 32P and covers in the clearance gap on the whole peripheries of the peripheral edge parts 21P, 32P while being raised to the outside. Thus, the clearance gaps of the peripheral edge parts 21P, 32P are surely sealed. In welding, the melt range extends to a side surface 27S of the groove 27, and the outer peripheral side of the weld metal (not shown) is opened. Thus, the occurrence of radial tensile stress in the weld metal is prevented, and crack of weld metal can be prevented, so that the liquid filling hole 28 can be sealed with favorable weld quality. The present embodiment produces the same effect as that of the first embodiment.

### Sixth Embodiment

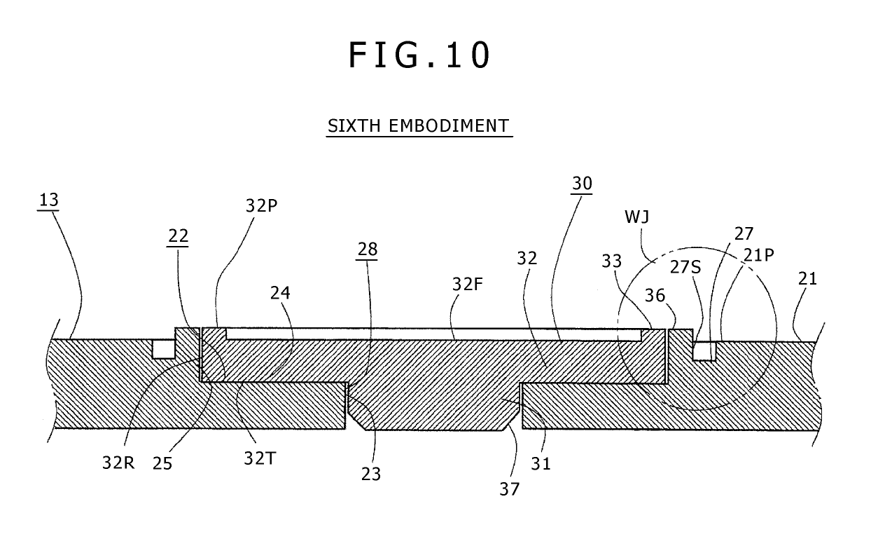

A sixth embodiment of a sealed type battery according to the invention will be described with reference to FIG. 10. In the drawing, the same or corresponding parts as those of the first embodiment are designated by the same reference numerals and the description is eliminated.

According to the sixth embodiment, in a welded joint WJ, the projection 33 of the first embodiment is provided in addition to the projection 36 and the groove 27 of the fifth embodiment.

As shown in FIG. 10, a peripheral edge part 32P of a liquid filling tap 30 is provided with only a projection 33 similar to that of the first embodiment, and not provided with a groove 34. On the other hand, an annular projection 36 is formed along the projection 33 similarly to the fifth embodiment on a peripheral edge part 21P in a lid 13, and an annular groove 27 is formed along the projection 36 on the outside of the projection 36.

In the present embodiment, the welded joint WJ is constituted by the projections 33, 36 and the groove 27. In welding, the melt range extends to a side surface 27S of the groove 27, and the outer peripheral side of weld metal (not shown) is opened. Thus, the occurrence of radial tensile stress in the weld metal is prevented, and crack of the weld metal can be prevented, so that a liquid filling hole 28 can be sealed with favorable weld quality. In welding, molten metal for weld metal (not shown) is supplied from the projections 33, 36. According to the present embodiment, an effect of increasing capacity of weld metal can be obtained in addition to the effects of the first and fifth embodiments.

### Seventh Embodiment

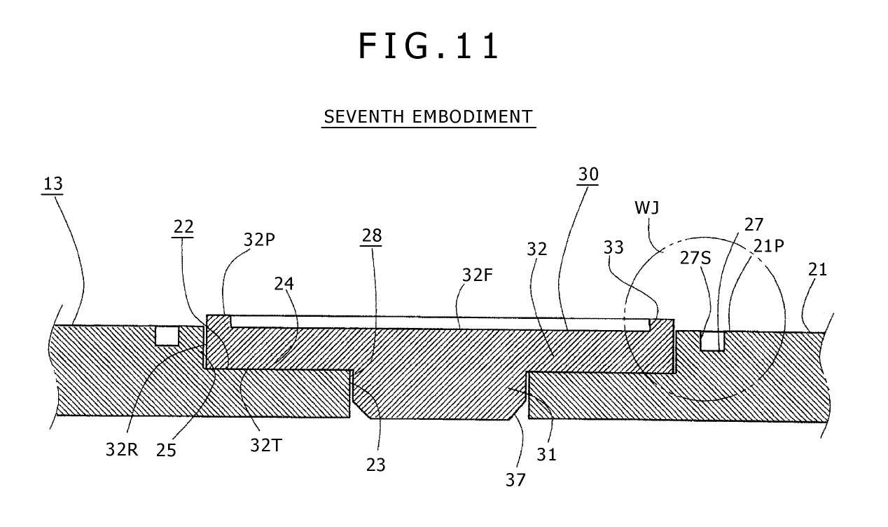

A seventh embodiment of a sealed type battery according to the invention will be described with reference to FIG. 11. In the drawing, the same or corresponding parts as those of the first embodiment are designated by the same reference numerals and the description is eliminated.

According to the seventh embodiment, a welded joint WJ is constituted by a groove 27 similar to that of the fifth embodiment and a projection 33 similar to that of the first embodiment.

As shown in FIG. 11, a peripheral edge part 32P of a liquid filling tap 30 is provided with only the projection 33 similar to that of the first embodiment, and is not provided with a groove 34. On the other hand, an annular groove 27 surrounding a fitting part 25 is formed at a position a little spaced from the fitting part 25 to the outside on a peripheral edge part 21P in a lid 13.

In welding, the melt range extends to a side surface 27S of the groove 27, and the outer peripheral side of weld metal (not shown) is opened. Thus, the occurrence of radial tensile stress in the weld metal is prevented, and crack of the weld metal can be prevented, so that a liquid filling hole 28 can be sealed with favorable weld quality. Further, in welding, molten metal for the weld metal (not shown) is supplied from the projection 33. The present embodiment produces the same effect as that of the first embodiment.

### Eighth Embodiment

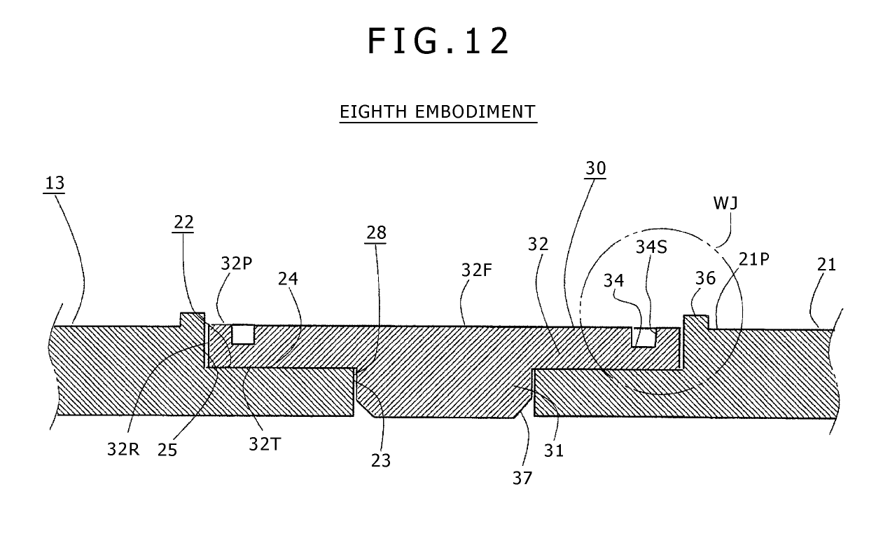

An eighth embodiment of a sealed type battery according to the invention will be described with reference to FIG. 12. In the drawing, the same or corresponding parts as those of the first embodiment are designated by the same reference numerals and the description is eliminated.

According to the eighth embodiment, a welded joint WJ is constituted by a projection 36 similar to that of the fifth embodiment and a groove 34 similar to that of the first embodiment.

As shown in FIG. 12, the annular groove 34 is formed along an outer peripheral surface 32R at a position a little spaced from the outer peripheral surface 32R to the inside on a peripheral edge part 32P of a liquid filling tap 30. On the other hand, the annular projection 36 is formed along a fitting part 25 on a peripheral edge part 21P in a lid 13.

In welding, the melt range extends a side surface 34S of the groove 34, and the outer peripheral side of weld metal (not shown) is opened. Thus, the occurrence of radial tensile stress in the weld metal is prevented and crack of the weld metal can be prevented, so that a liquid filling hole 28 can be sealed with favorable weld quality. Further, in welding, molten metal for the weld metal (not shown) is supplied from the projection 36. The present embodiment produces the same effect of the first embodiment.

### Ninth Embodiment

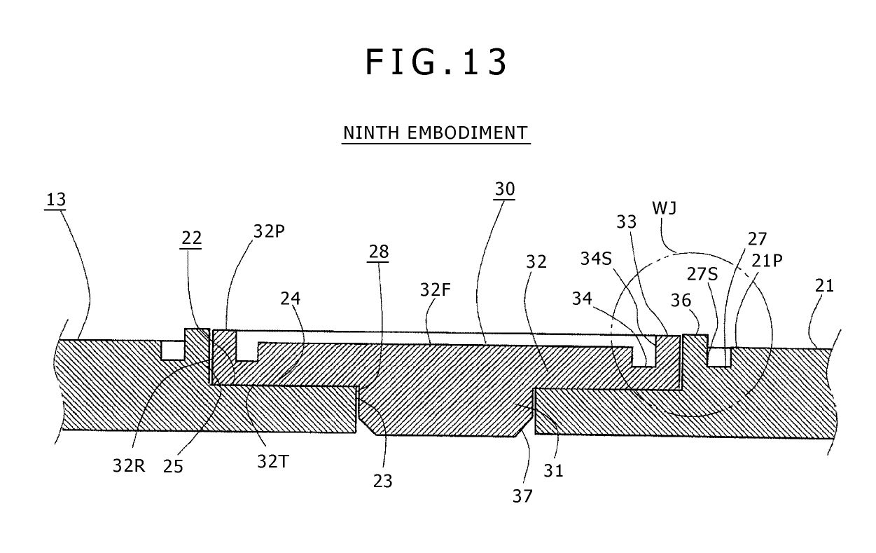

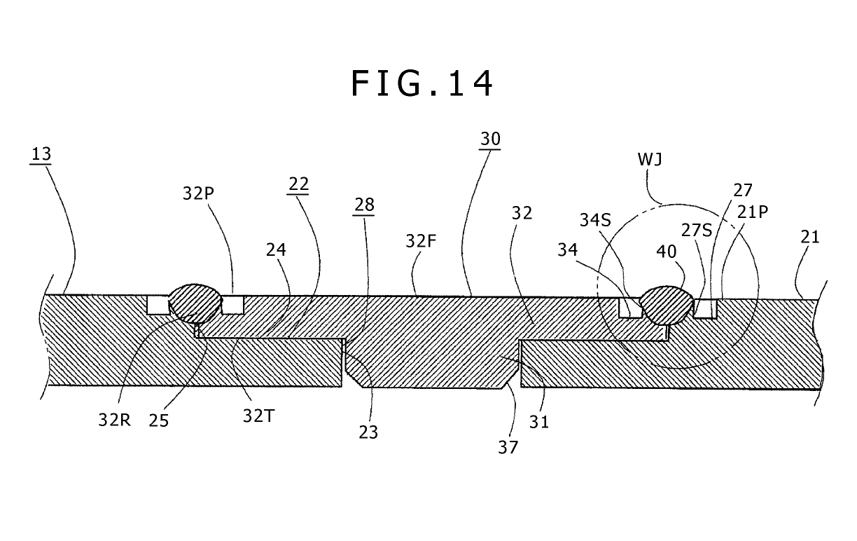

A ninth embodiment of a sealed type battery according to the invention will be described with reference to FIG. 13 and FIG. 14. In the drawings, the same or corresponding parts as those of the first embodiment are designated by the same reference numerals and the description is eliminated.

According to the ninth embodiment, a welded joint WJ is constituted by a projection 33 and a groove 34 similar to those of the first embodiment and a projection 36 and a groove 27 similar to those of the fifth embodiment.

In welding, the melt range extends to a side surface 34S of the groove 34 and a side surface 27S of the groove 27, and the inner and outer peripheries of weld metal 40 (FIG. 14) are opened. Thus, there is no radial tensile stress in the weld metal, so that a liquid filling hole 28 can be sealed with very favorable weld quality.

In welding, molten metal for the weld metal (not shown) is supplied from both of the projections 33, 36, and an abundant supply is obtained. Also in this respect, the weld quality is improved. The present embodiment produces the effects of increasing molten metal supply amount and also not causing any stress in addition to the effect of the first embodiment.

### Tenth Embodiment

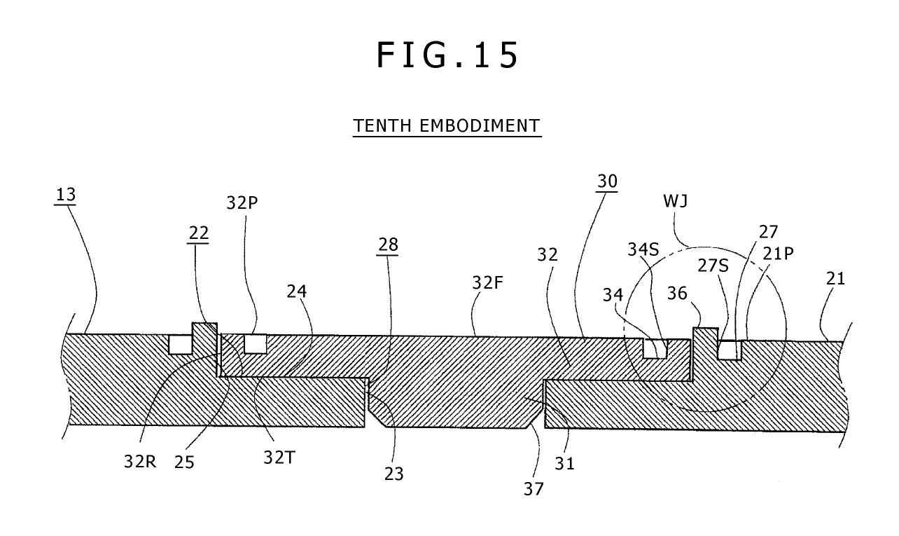

A tenth embodiment of a sealed type battery according to the invention will be described with reference to FIG. 15. In the drawing, the same or corresponding parts as those of the first embodiment are designated by the same reference numerals and the description is eliminated.

According to the tenth embodiment, a welded joint WJ is constituted by a groove 34 similar to that of the first embodiment and a projection 36 and a groove 27 similar to those of the fifth embodiment.

In welding, the melt range extends to a side surface 34S of the groove 34 and a side surface 27S of the groove 27, and the inner and outer peripheries of weld metal (not shown) are opened. Thus, there is no radial tensile stress in the weld metal, so that a liquid filling hole 28 can be sealed with very favorable weld quality. Further, in welding, molten metal for the weld metal (not shown) is supplied from the projection 36.

According to the present embodiment, the effect of not causing any stress can be obtained in addition to the effect of the first embodiment.

### Eleventh Embodiment

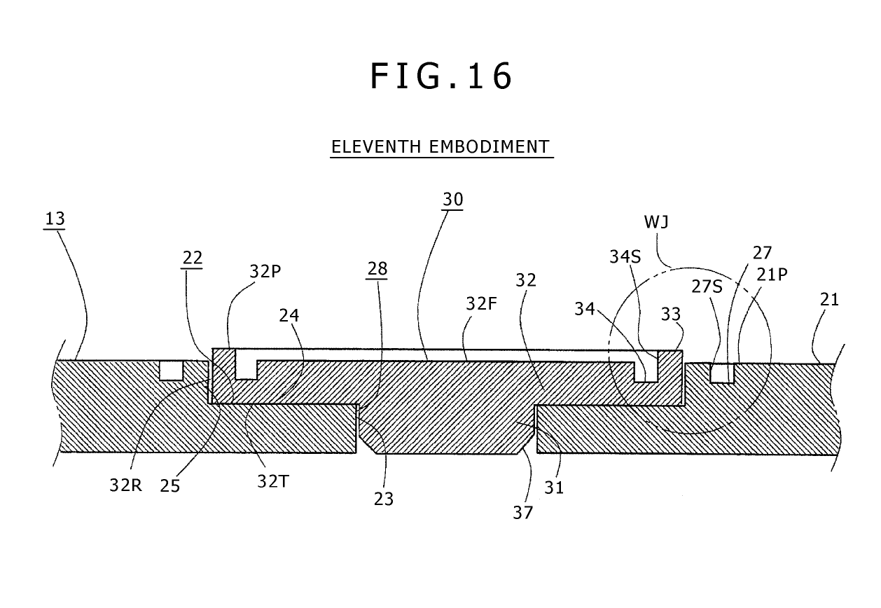

An eleventh embodiment of a sealed type battery according to the invention will be described with reference to FIG. 16. In the drawing, the same or corresponding parts as those of the first embodiment are designated by the same reference numerals and the description is eliminated.

According to the eleventh embodiment, a welded joint WJ is constituted by a projection 33 and a groove 34 similar to those of the first embodiment and a groove 27 similar to that of the seventh embodiment.

In welding, the melt range extends to a side surface 34S of the groove 34 and a side surface 27S of the groove 27, and the inner and outer peripheries of weld metal (not shown) are opened. Thus, there is no radial tensile stress in the weld metal, so that a liquid filling hole 28 can be sealed with very favorable weld quality. Further, in welding, molten metal for the weld metal (not shown) is supplied from the projection 33.

According to the present embodiment, the effect of not causing any stress can be obtained in addition to the effect of the first embodiment.

### Twelfth Embodiment

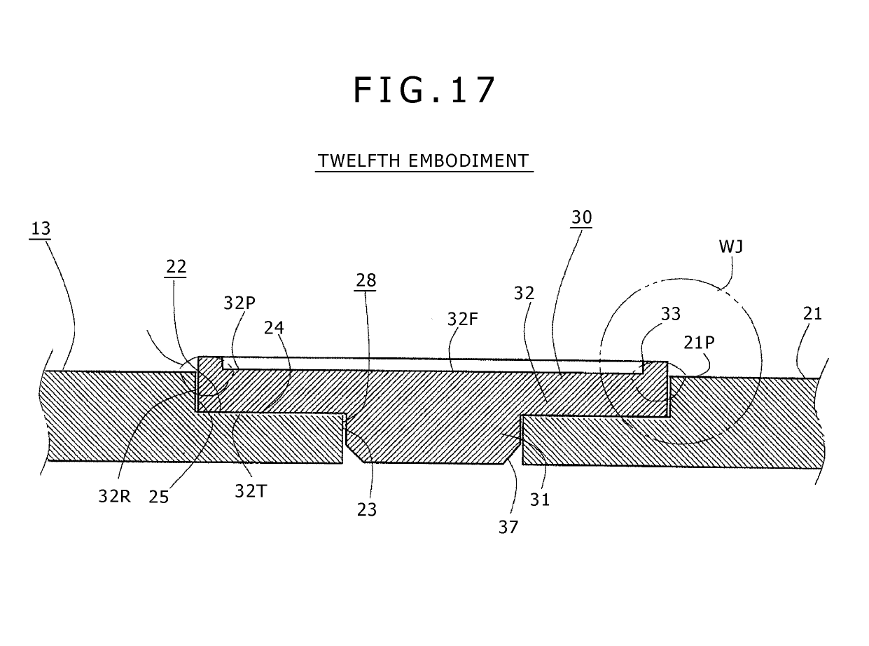

A twelfth embodiment of a sealed type battery according to the invention will be described with reference to FIG. 17. In the drawing, the same or corresponding parts as those of the first embodiment are designated by the same reference numerals and the description is eliminated.

According to the twelfth embodiment, the groove 34 in the first embodiment is eliminated, and a welded joint WJ is constituted by a projection 33 and a peripheral edge part 21P.

In welding, molten metal for weld metal 40 (indicated by a phantom line) is supplied from the projection 33. The molten metal stays on peripheral edge parts 21P, 32P due to its surface tension, and covers in the clearance gaps of the whole peripheries of the peripheral edge parts 21P, 32P while being raised to the outside. Thus, the clearance gaps of the peripheral edge parts 21P, 32P are surely sealed.

### Thirteenth Embodiment

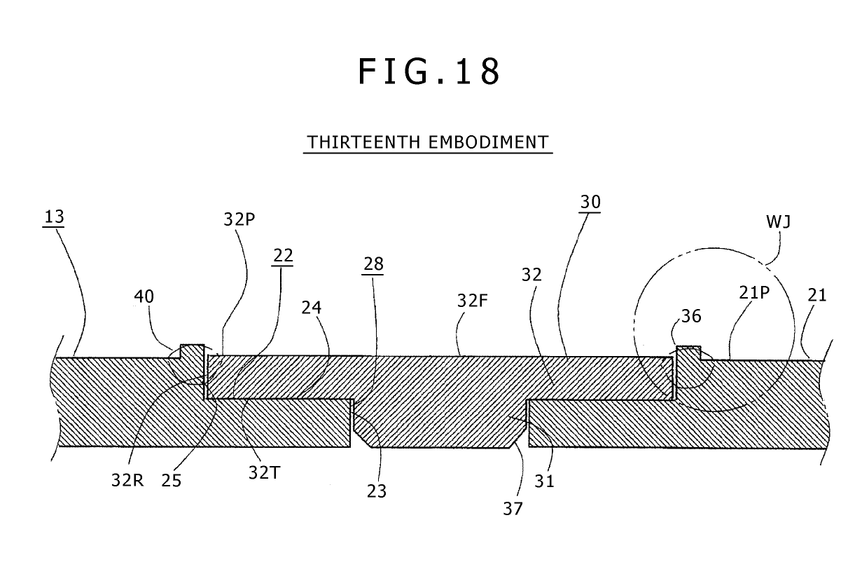

A thirteenth embodiment of a sealed type battery according to the invention will be described with reference to FIG. 18. In the drawing, the same or corresponding parts as those of the first embodiment are designated by the same reference numerals and the description is eliminated.

According to the thirteenth embodiment, the groove 27 in the fifth embodiment is eliminated and a welded joint WJ is constituted by a projection 36 and a peripheral edge part 32F.

In welding, molten metal for weld metal 40 (indicated by a phantom line) is supplied from the projection 36. The molten metal stays on the peripheral edge parts 21P, 32P due to its surface tension and covers in the clearance gaps on the whole peripheries of the peripheral edge parts 21P, 32P while being raised to the outside on the projecting side. Thus, the clearance gaps of the peripheral edge parts 21P, 32P are surely sealed.

### Fourteenth Embodiment

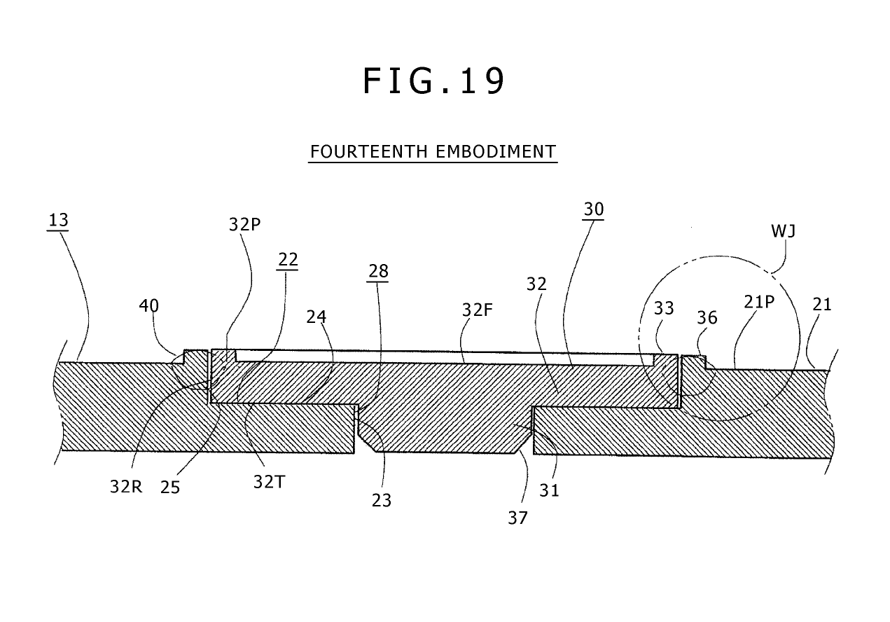

A fourteenth embodiment of a sealed type battery according to the invention will be described with reference to FIG. 19. In the drawings, the same or corresponding parts as those of the first embodiment are designated by the same reference numerals and the description is eliminated.

According to the fourteenth embodiment, the groove 34 in the fourth embodiment is eliminated, and a welded joint WJ is constituted by projections 33, 36. In welding, molten metal for weld metal 40 (indicated by a phantom line) is supplied from the projections 33, 36. The molten metal stays peripheral edge parts 21P, 32P due to its surface tension, and covers in the clearance gaps on the whole peripheries of the peripheral edge parts 21P, 32P while being raised to the outside on the projecting side. Thus, the clearance gaps of the peripheral edge parts 21P, 32P are surely sealed.

### [Modification]

Although the projections 33, 36 and the grooves 34, 27 are formed annularly in the above embodiments, the projections 33, 36 and the grooves 34, 37 may be disposed to be dispersive (intermittently) without being provided on the whole periphery.

Further, the cross sectional form of the fitting part 25 is not limited to a circle, but an ellipse, a polygon and so on maybe adopted. In this case, the head part 32 is shaped corresponding thereto. The projections 33, 36 and the grooves 34, 37 should be shaped along the outer peripheral surface 32R of the head part 32.

Although the above description deals with the lithium secondary battery, this invention can be applied to any kind of battery when the secondary battery is of such a type that after a battery can is sealed with a lid, the interior of the can is filled with a liquid such as a liquid electrolyte from a liquid filling hole of the lid, and subsequently the liquid filling hole is sealed with a liquid filling tap by welding. Therefore, the shape of the battery can is not limited to a prismatic form, but an elliptic form, a cubic form and so on may be adopted.

The disclosure contents of the following priority basic application are incorporated herein as a cited document.

Japanese Patent Application No. 2010-156496 (filed on Jul. 9, 2010)

1. A sealed type battery, comprising:
a can for storing an electrode winding group;
a lid which has a liquid filling hole for injecting a liquid electrolyte and seals an opening of the can; and
a liquid filling tap which is fitted to the liquid filling hole and seals the liquid filling hole by welding thereto, wherein a projection which is molten in welding is provided on one of the outer surfaces of the liquid filling tap and the outer surface of the lid connected to the liquid filling hole, the liquid filling tap is welded to the liquid filling hole using molten metal of the projection in welding as well, and the a side of the weld metal is opened.

2. The sealed type battery according to claim 1, wherein the projection is protruded from the outer surface of an outer peripheral edge of the liquid filling tap and formed annularly.

3. The sealed type battery according to claim 2, wherein an annular groove recessed from the outer surface of the liquid filling tap is formed on the inside of the projection projected from the outer surface of the liquid filling tap, and some molten metal in welding is exposed to the groove and solidified.

4. The sealed type battery according to claim 1, wherein the projection is protruded from the outer surface of the lid connected to an inner peripheral surface of the liquid filling hole and formed annularly.

5. The sealed type battery according to claim 4, wherein an annular groove recessed from the outer surface of the lid is formed on the outside of the projection projected from the outer surface of the lid, and some molten metal in welding is exposed to the groove and solidified.

6. The sealed type battery according to claim 1, wherein the projection includes:
a first annular projection protruded from the outer surface of an outer peripheral edge of the liquid filling tap and formed annularly; and a second annular projection protruded from the outer surface of the lid adjacent to an inner peripheral surface of the liquid filling hole and formed annularly.

7. The sealed type battery according to claim 6, wherein a first annular groove recessed from the outer surface of the liquid filling tap is formed on the inside of the first annular projection projected from the outer surface of the liquid filling tap, and some molten metal in welding is exposed to the first groove and solidified.

8. The sealed type battery according to claim 6, wherein a second annular groove recessed from the outer surface of the lid is formed on the outside of the second annular projection projected from the outer surface of the lid, and some molten metal in welding is exposed to the second groove and solidified.

9. The sealed type battery according to claim 6, wherein a first annular groove recessed from the outer surface of the liquid filling tap is formed on the inside of the first annular projection projected from the outer surface of the liquid filling tap, a second annular groove recessed from the outer surface of the lid is formed on the outside of the second annular projection projected from the outer surface of the lid, and some molten metal in welding is exposed to the first and second grooves and solidified.

10. The sealed type battery according to any one of claim 1, wherein the liquid filling hole has a large diameter part and a small diameter part which form a step part, the liquid filling tap includes: a head part which is on the step part and fitted to the large diameter part; and a shaft part which is fitted to the small diameter part and whose shaft center is aligned therewith, and an outer peripheral edge of the head part is welded to an inner peripheral edge of the large diameter part of the liquid filling hole.

11. The sealed type battery according to claim 10, wherein the lid is increased in wall thickness at a portion corresponding to the small diameter part, and the shaft part of the liquid filling tap is formed to have a length equal to the wall thickness.

12. The sealed type battery according to any one of claim 1, wherein the liquid filling tap is circular, and the projection is an annular projection.

13. The sealed type battery according to any one of claim 1, wherein the projection is projected from the outer surface of the liquid filling tap or the outer surface of the lid so that the top face thereof is located at a position protruded from the outer surface of the lid.

14. The sealed type battery according to claim 2, wherein an annular groove recessed from the outer surface of the lid is formed along an outside of the inner peripheral surface of the liquid filling hole, and some molten metal in welding is exposed to the groove and solidified.

15. The sealed type battery according to claim 3, wherein an annular groove recessed from the outer surface of the lid is formed along the outside of an inner peripheral surface of the liquid filling hole, and some molten metal in welding is exposed to the grooves of the liquid filling tap and the lid and solidified.

16. The sealed type battery according to claim 4, wherein an annular groove recessed from the outer surface of the liquid filling tap is formed on a peripheral edge part of the liquid filling tap, and some molten metal in welding is exposed to the groove and solidified.

17. The sealed type battery according to claim 5, wherein an annular groove recessed from the outer surface of the liquid filling tap is formed on a peripheral edge part of the liquid filling tap, and some of molten metal in welding is exposed to the grooves of the liquid filling tap and the lid and solidified.
